(19) United States
(12) Patent Application Publication
(10) Pub. No.: US 2013/0151348 A1
(43) Pub. Date: Jun. 13, 2013

(54) METHOD AND SYSTEM FOR BUILDING AN INFLUENCE COMMERCE NETWORK AND USE THEREOF

(71) Applicants: Sanjoy Paul, Bangalore (IN); Santosh Krishnamurthy, Bangalore (IN)

(72) Inventors: Sanjoy Paul, Bangalore (IN); Santosh Krishnamurthy, Bangalore (IN)

(73) Assignee: INFOSYS LIMITED, Bangalore (IN)

(21) Appl. No.: 13/359,823

(22) Filed: Jan. 27, 2012

(30) Foreign Application Priority Data
Dec. 7, 2011 (IN) 4249/CHE/2011

(51) Int. Cl. G06Q 30/02

(52) U.S. Cl. 705/14.66; 705/14.49

(57) ABSTRACT

A method for generating an influence commerce network that facilitates to identify targeted users for promotion of products is provided. The method enables generating a product network using data related to products in an ecommerce website. The generated product network represents product-product links which represent relationship between related products from amongst the products. The method further enables generating a user network using data related to users present in a social networking website. The user network represents community links which represent relationship between users. Furthermore, the method enables analyzing data related to the user network and the product network and connecting the product network and the user network based on the analyzed data to generate an influence commerce network. The influence commerce network represents community-product links that further represents relationship between users in the user network and products in the product network.

### FIELD OF THE INVENTION

The present invention relates generally to the field of promotion and purchase of products using electronic commerce (e-commerce) and more specifically to modeling e-commerce networks and identifying targeted users for promotion of products employing social networking websites.

### BACKGROUND OF THE INVENTION

Growth of Internet has facilitated rapid increase in selling of products online by retailers, distributors and auctioneers to users via e-commerce networks. Examples of e-commerce networks may include Storefront, Amazon, Kmart.com, Xtreme Mac, Ikea etc. E-commerce applications allow users to browse through online products for viewing content related to the products such as pictures, trailers, product specification, description and offers. The e-commerce applications also allow the users to purchase products of interest using credit cards or any other mode of payment over multiple channels like Television (TV), Personal Computer (PC) and mobile phone. Further, the e-commerce applications allow users to rate products, write a review or comment on product which can be read by other users of e-commerce network.

Social networking websites are widely used to view user's profile information such as location, interests, hobbies, occupation etc. The social networking websites provide a platform to users to connect with other users based on common interests and ties. Examples of some popular social networking websites may include MySpace, Orkut, Facebook, LinkedIn and Hi5. Social networking applications facilitate users to share feedback and reviews related to various activities which the user performs with other users via instant messaging, electronic-mail or communicating on a discussion forum, while accessing information over multiple channels like Television (TV), Personal Computer (PC) and mobile phone.

Many of the e-commerce websites adopt different advertising modes for promoting products for sale to users. Certain e-commerce networking websites also facilitate promotion of products by providing access to user's social networking profile in a social networking website. The user may in turn connect with other users to share a review of the product he purchased. For example, a user may buy a camera from an e-commerce network and then write a review or inform other users on a social networking website about the camera.

Conventionally, most of the promotional strategies employed by retailers are limited to browsing history of purchases made by user or products viewed by the user. Current systems do not facilitate identifying targeted users based on interests of the users as presented in social networking websites for marketing products. The current systems do not capitalize on relationship existing between users of social networking websites and products listed in an e-commerce website for identifying potential users of products.

In light of the above, there is a need for a system and method for integrating e-commerce networks with social networking websites for identifying targeted users to buy products. Further, there is a need for a system and method for modeling product networks in e-commerce websites and establish relationship between related products. In addition, there is a need for a system and method for connecting product networks with social networking websites based on behavior and interests of users towards various products.

### SUMMARY OF THE INVENTION

A computer-implemented method for generating an influence commerce network that facilitates to identify one or more targeted users for promotion of products is provided. In various embodiments of the present invention, the computer-implemented method comprises generating a product network, via program instructions executed by a computer system, using data related to a plurality of products in an ecommerce website. The generated product network represents one or more product-product links which represent relationship between related products from amongst the plurality of products. The method further comprises generating a user network, via program instructions executed by a computer system, using data related to users present in a social networking website. The user network represents one or more community links which represent relationship between users. Furthermore, the method comprises analyzing data, via program instructions executed by a computer system, related to the user network and the product network. The method further comprises connecting, via program instructions executed by a computer system, the product network and the user network based on the analyzed data to generate an influence commerce network. The influence commerce network represents one or more community-product links that represent relationship between users in the user network and products in the product network for identifying one or more targeted users of products.

In an embodiment of the present invention, generating a product network using data related to products in an ecommerce website comprises identifying data related to the plurality of products, via program instructions executed by a computer system, from the ecommerce networking website. The data related to the plurality of products comprises at least one of: product description, product specification, and cost of products. Further, the method comprises aggregating the plurality of products, via program instructions executed by a computer system, into a plurality of product groups based on the identified data. Furthermore, the method comprises establishing one or more product-product links between at least two of the plurality of product groups, via program instructions executed by a computer system, wherein the product-product links represent relationship between the product groups. Furthermore, the method comprises deriving strength of each of the product-product links, via program instructions executed by a computer system, based on one or more predetermined factors. The strength represents effectiveness of each of the product-product links. The method further comprises assigning a product-product weight to each of the product-product links, via program instructions executed by a computer system, based on the derived strength of each of the product-product links.

In another embodiment of the present invention, establishing one or more product-product links between at least two of the plurality of product groups comprises establishing a common product-product link between product groups which comprise common product and a similar product-product link between product groups which comprise similar products.

In an embodiment of the present invention, deriving strength of each of the product-product links comprises determining if the product-product links are a strong link or a weak link based on one or more predetermined factors. The predetermined factors include at least one of: number of products in the product groups, number of common users viewing products in each product group, and products purchased by common users.

In an embodiment of the present invention, the strength of each of the product-product links may be derived using the following equation:

$$\cdot P : {S}_{i} = {\sum }_{K = 1}^{K = N} {S}_{k , l}$$

where, P Si represents product group strength, k represents a user of the product group, N represents number of users of the product group and Sk,i represents strength of each product in the product group, wherein Sk,i is determined based on the one or more predetermined factors.

In an embodiment of the present invention, assigning a product-product weight to each of the product-product links comprises assigning a weight on a scale of 1 to 10 based on the derived strength.

In another embodiment of the present invention, the product-product weight corresponding to each product-product link is determined by the following equation:

$${PW}_{ij} = {\sum }_{K = 1}^{k = N} {S}_{k , ij}$$

where, PWij represents product-product weight of a product-product link connecting two product groups Pi and Pj, Sk,ij represents strength of product groups Pi and Pj and N represents number of common users between two product groups Pi and Pj.

In yet another embodiment of the present invention, generating a user network using data related to users in a social networking website comprises obtaining data related to the plurality of users, via program instructions executed by a computer system, from the social networking website. The data related to the plurality of users facilitate determining interactions of the plurality of users in the social networking website. The method further comprises aggregating the plurality of users, via program instructions executed by a computer system, into a plurality of communities based on the obtained data. The plurality of communities represent interest areas of the one or more users. The method further comprises establishing one or more community links between at least two of the plurality of communities via program instructions executed by a computer system. The one or more community links represent relationship between the communities. The method further comprises deriving strength of each of the community links, via program instructions executed by a computer system, using one or more predetermined factors. The strength represents effectiveness of each of the community links. Further, the method comprises assigning a community-community weight to each of the links, via program instructions executed by a computer system, based on the derived strength of each of the community links.

In an embodiment of the present invention, the strength of each of the community links may be derived using the following equation:

$${CS}_{i} = {\sum }_{K = 1}^{K = N} {S}_{k , l}$$

where, CSi represents community strength, k represents a user of the product group, N represents number of users in the community and Sk,i represents strength of each community link, wherein Sk,i is determined based on the one or more predetermined factors.

In another embodiment of the present invention, the community-community weight corresponding to each community link is determined by the following equation:

$${CW}_{ij} = {\sum }_{K = 1}^{k = N} {S}_{k , ij}$$

where CWij represents weight of a link connecting communities Ci and Cj, Skij represents strength of each link between Ci and Cj, k represents user and N represents number of common users between communities Ci and Cj.

In another embodiment of the present invention, connecting the product network and the user network to build an Influence commerce network comprises deriving strength of each of the community-product links, via program instructions executed by a computer system, based on one or more predetermined factors. The strength represents effectiveness of each of the community-product links. The method comprises assigning a community-product weight to each of the links, via program instructions executed by a computer system, based on the derived strength of each of the community-product links.

In an embodiment of the present invention, the community-product weight corresponding to each of the community-product link is determined by the following equation:

$$C P {W}_{ij} = {\sum }_{k = 1}^{k = N} {\sum }_{l = 1}^{l = {n}_{k}} {S}_{l , ij}$$

CPWij represents weight of community-product link connecting community Ci and product group Pj, N represents number of users in Ci associated with a product from product group Pj, nk represents number of products in Pj with which a user in Ci is associated and (Sl,ij) represents strength of each association of user with products

In various embodiments of the present invention, a method for identifying a targeted user for promotion of products using an influence commerce network is provided. The method comprises mapping a product, via program instructions executed by a computer system, to a product group in an influence commerce network. The product is mapped to the product group based on characteristics of the product. The method further comprises identifying one or more community-product links via program instructions executed by a computer system. The community-product links connect the product group to one or more communities in the influence commerce network. Further, the method comprises computing a mean weight value, via program instructions executed by a computer system, for each of the identified community-product links and selecting a community-product link based on the computed mean weight value. The selected community-product link connects the product group to one or more communities. Further, the method comprises identifying one or more users, via program instructions executed by a computer system, from the one or more communities connected to the product group by the selected community-product link.

In an embodiment of the present invention, mapping a product to a product group in an influence commerce network comprises identifying a product group in an influence commerce graph representative of the influence commerce network based on characteristics of the product. The product group is represented as a node in the influence commerce graph. The method further comprises mapping the product to the identified product group.

In an embodiment of the present invention, identifying one or more community-product links that connect the product group to one or more communities in the influence commerce network comprises determining the community-product links which connect the identified product group node to one or more community nodes in the influence commerce graph. The method further comprises identifying the community links in a community plane of the influence commerce graph that correspond to the community-product links. Further, the method comprises determining relationship between users associated with the communities which are connected by the identified community links. The relationship is determined using information from the community links. Furthermore, the method comprises identifying one or more community-product links based on the determined relationships, wherein the relationship between users signifies the extent of influence one user in a community has on another user of one or more communities. The communities are connected by the community links that correspond to the community-product links.

In an embodiment of the present invention, computing a mean weight value for each of the identified community-product links comprises computing a mean weight value of the weights assigned to the identified community-product links.

In another embodiment of the present invention, selecting a community-product link based on the computed mean weight value comprises at least one of: selecting a community-product link with largest mean weight value, selecting a community-product link with shortest path in the influence commerce graph if at least two community-product links have same computed mean value and selecting a community-product link based on market conditions.

A system for building an influence commerce network that facilitates to identify a targeted user for promotion of products is provided. The system comprises a first interface module in communication with a processing unit and configured to generate a product network using data related to a plurality of products in an ecommerce website. The product related data is stored in a memory. Further, the product network includes one or more product-product links which represent relationship between related products from amongst the plurality of products. The system further comprises a second interface module in communication with the processing unit and configured to generate a user network using data related to users present in a social networking website. The user related data is stored in the memory. Further, the user network includes one or more community links which represent relationship between users. Further, the system comprises an influence commerce network management module in communication with the processing unit and configured to receive data related to the user network and the product network from the first and second interface modules respectively and storing the received data in the memory and analyze the received data and connect the product network and the user network based on the analyzed data to generate an influence commerce network. The influence commerce network includes one or more community-product links that represent relationship between users in the user network and products in the product network.

In an embodiment of the present invention, the system further comprises an activity tracker in communication with the processing unit and configured to monitor activities of the users in the social networking website and users in the ecommerce website, identify data related to activities which are relevant for generating an influence commerce network and send the identified data to the influence commerce network management module.

In another embodiment of the present invention, the influence commerce network management module comprises a data analyzer. The data analyzer is in communication with the processing unit and configured to receive and analyze data received from the first and second interface modules respectively.

In an embodiment of the present invention, the influence commerce network management module comprises a data analyzer. The data analyzer is in communication with the processing unit and configured to receive and analyze the data received from the activity tracker.

In another embodiment of the present invention, the influence commerce network management module comprises an influence commerce network builder. The influence commerce network builder is in communication with the processing unit and configured to process the analyzed data and generate the influence commerce network.

In an embodiment of the present invention, the influence commerce network management module comprises a network store. The network store is configured to store data related to the influence commerce network.

In another embodiment of the present invention, the system further comprises an influence commerce network engine in communication with the processing unit and configured to generate an influence commerce graph representing the influence commerce network using the data stored in the network store.

In an embodiment of the present invention, the influence commerce network engine comprises an influence network analyzer. The influence network analyzer is in communication with the processing unit and configured to receive and analyze the data stored in the network store. The influence commerce network engine further comprises an influence graph builder. The influence graph builder is in communication with the processing unit and configured to receive the analyzed data from the influence network analyzer and generate a graph using the analyzed data.

In another embodiment of the present invention, the influence commerce network engine comprises a strategy identifier in communication with the processing unit and configured to facilitate determining one or more strategies for promotion of products using the generated influence commerce graph. The influence commerce network engine further comprises a target mapping module in communication with the processing unit and configured to map a product in the product network using the generated influence commerce graph based on the determined one or more strategies. The mapping is performed based on one or more characteristics of the product. The target mapping module is further configured to identify a targeted user in the user network for promotion of a product in the product network using the generated influence commerce graph based on the mapping.

### BRIEF DESCRIPTION OF THE DRAWINGS

The present invention is described by way of embodiments illustrated in the accompanying drawings wherein:

FIG. 1 is a block diagram of a system that facilitates building an influence commerce network, in accordance with various embodiments of the present invention;

FIG. 2A illustrates a pictorial representation of product network in an e-commerce network, in accordance with an embodiment of the present invention;

FIG. 2B illustrates a representation of product links between two product groups in a product network;

FIG. 3A illustrates a pictorial representation of a user network in a social network, in accordance with an embodiment of the present invention;

FIG. 3B illustrates a representation of community links between two communities in a user network;

FIGS. 4 and 7 illustrates a graphical representation of an influence commerce network, in accordance with an embodiment of the present invention;

FIG. 5 is a flowchart illustrating a method for building an influence commerce network, in accordance with an embodiment of the present invention; and

FIG. 6 is a flowchart illustrating a method for identifying a targeted user for promotion of products, in accordance with an embodiment of the present invention.

### DETAILED DESCRIPTION

A system and method for modeling e-commerce networks and identifying targeted users for promotion of products is provided. The invention facilitates forming a product network based on relationships between different products listed in the e-commerce networks. The invention facilitates modeling product networks by establishing links between related products. The invention further facilitates assigning weights to the links by determining strength of each of the links based on one or more predetermined factors. Furthermore, the invention facilitates forming an influence commerce network by connecting the product network with social network based on user interests and behavior of users towards products. The invention provides for identifying potential users of a product using the influence commerce network for targeted promotion and advertisement of products.

The disclosure is provided in order to enable a person having ordinary skill in the art to practice the invention. Exemplary embodiments herein are provided only for illustrative purposes and various modifications will be readily apparent to persons skilled in the art. The general principles defined herein may be applied to other embodiments and applications without departing from the spirit and scope of the invention. The terminology and phraseology used herein is for the purpose of describing exemplary embodiments and should not be considered limiting. Thus, the present invention is to be accorded the widest scope encompassing numerous alternatives, modifications and equivalents consistent with the principles and features disclosed herein. For purpose of clarity, details relating to technical material that is known in the technical fields related to the invention have been briefly described or omitted so as not to unnecessarily obscure the present invention.

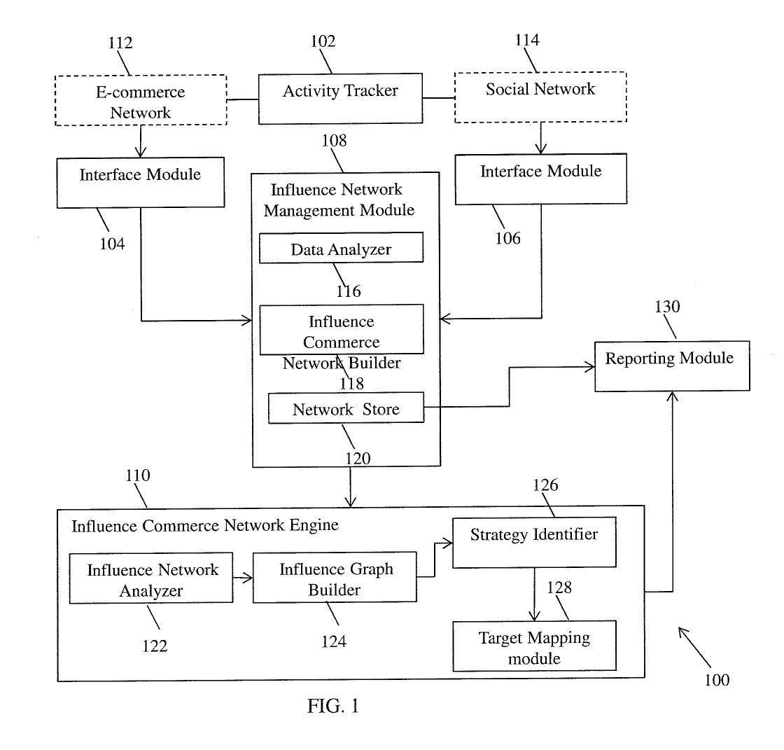

FIG. 1 is a block diagram of a system 100 that facilitates building an influence commerce network, in accordance with various embodiments of the present invention. The system 100 comprises an activity tracker 102, interface modules 104,106, influence commerce network management module 108 and an influence commerce network engine 110. The system 100 interacts with an e-commerce network 112 and a social network 114.

The activity tracker 102 is a software module configured to monitor activities performed by users in the e-commerce network 112 and social network 114. In an embodiment of the present invention, the activities performed by a user in an e-commerce network 112 may include browsing or searching for products, viewing content associated with products, viewing similar products in a product catalog, viewing bundle offers that group similar products or group products that are purchased together (e.g. camera and camera case). In another embodiment of the present invention, the activities performed by users in a social network 114 may include browsing user profile, sending recommendation to other users via messaging regarding various activities such as products viewed, products purchased etc. The activities may also include users of social networking websites and e-commerce websites communicating with the external users using voice call, electronic mail etc. The activity tracker 102 identifies activities that are relevant to the influence commerce network and sends the identified activities to the influence commerce network management module 108.

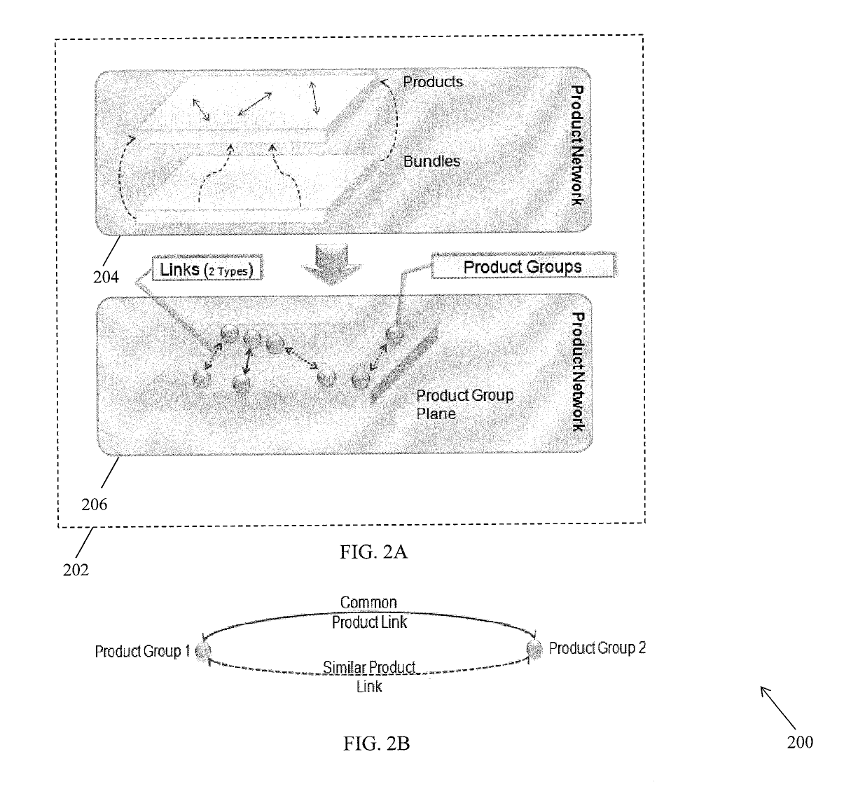

The interface modules 104, 106 are software modules configured to connect the system 100 to e-commerce network 112 and social network 114. In an embodiment of the present invention, the interface module 104 generates a product network based on product-related data obtained from e-commerce network 112. The interface module 104 is depicted in FIG. 2A, in an exemplary embodiment of the present invention. FIG. 2A illustrates a pictorial representation of product network 202 in an e-commerce network which is modeled in an e-commerce network 112 by establishing relationships between various products listed in the e-commerce network 112. Relationship is established by determining product groups. In an embodiment of the present invention, product groups include groups of similar products such as digital cameras, books related to photography etc. In another embodiment of the present invention, product groups include groups of common products such as digital cameras, camcorder etc. A particular product is linked to either similar or common product groups.

In an embodiment of the present invention, as shown in FIG. 2A, the product network 202 is modeled by aggregating products into product groups and relationships into links in a single plane referred as product group plane. The single plane has a layered architecture. One layer represents product layer 204 and the layer below the product layer 204 represents one or more product group layer 206. The two layers 204, 206 may be aggregated to form a product network 202. In the product network 202, product groups are represented by nodes. The nodes are connected by links (also referred as product links) which represent relationship between the product groups. In an embodiment of the present invention, as shown in FIG. 2B, the product links include a common product link and similar product link. Common product link is established between two product groups when the product groups have common products, for example, Single-Lens Reflex (SLR) digital camera in one product group and camcorder in another product group. Similar product link represents a relation between two product groups that have related products, for example, SLR Camera in one product group and photography guide in another product group. In an embodiment of the present invention, two product groups can be linked with either a common product link or a similar product link. In another embodiment of the present invention, two product groups can be linked with both common product link and similar product link.

Each of the product links in the product network 202 possesses different levels of strength which is determined based on one or more factors. Strength determines effectiveness of a link and allows comparison of two links. Factors that determine strength of each link are dependent on the type of link. In an exemplary embodiment of the present invention, strength of a link may include a weak link or a strong link. One of the factors that establish a ‘common product link’ as a weak link may include ‘less number of products’ in a product group. A factor that establishes a common product link as a strong link may include ‘more number of products’ in a product group. Factors that establish a similar product link as a weak link may include ‘products in a product group not viewed in a single session’ by users and ‘products in a product group not purchased together (e.g. camera and camera case)’ by users. Factors that establish a ‘similar product group’ as a strong link may include ‘products commonly viewed in same session’ by users and ‘products commonly purchased by users. In an embodiment of the present invention, common product link is stronger than similar product link. Each of the links is assigned a product-product weight based on strength of the links. In an embodiment of the present invention, each of the links is assigned a product-product weight on a scale of 1 to 10. The weights represent relationship between different products and relationship between products and users.

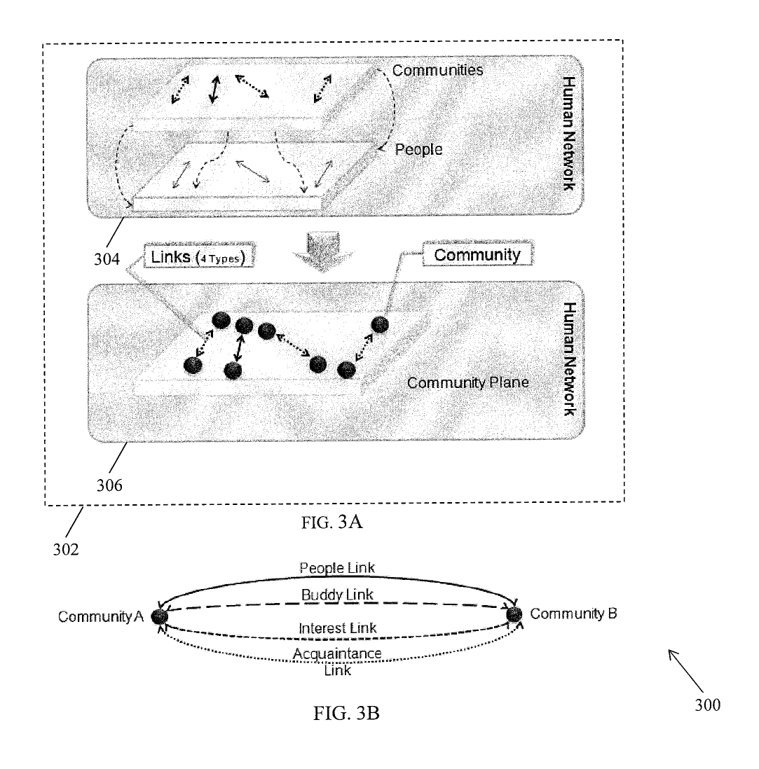

In another embodiment of the present invention, the interface module 106 generates a user network based on user-related data obtained from social-network 114. The user network is depicted in FIG. 3A, in an exemplary embodiment of the present invention. FIG. 3A illustrates a pictorial representation of a user network 302 in a social network. Users in a social network may comprise three categories of users based on the user's intent to adopt a new feature or content. The first category may include leaders. Leaders comprise a group of users who like to adopt a new product, feature or content and wish to be unique and the first user in case of any dealings related to the product, feature and content. The second category may include mainstream users. Mainstream comprises of a group of users who would adopt a product, feature or content only after a known user has either adopted it or recommended it. The third category may include laggards. Laggards comprise of a group of users who are satisfied with basic features and demonstrate little or no inclination towards adapting anything new. Social networking websites represent relationships between user with other users, user with communities and user with community members. Using information from social networking websites, a user network 302 may be formed which is a representation of users and relationship between users. The user network 302 may be represented using networked nodes and links between them. Nodes represent entities like users, community members, and communities while links represent relationship between the nodes that are connected by the links.

In an embodiment of the present invention, the user network 302 is modeled by aggregating users into communities and relationships into links in a single plane referred as community plane. The community plane has a layered architecture. One layer 304 represents communities and relationship between these communities and the layer 306 below the layer 304 represents users and their relationships with each other. The two layers may be aggregated to form a user network 302. The nodes are connected by links (also referred as community links) which represent relationship between the communities. Relationships can be determined either by similarities between two communities or based on behavior of the users who are part of a community. The communities represent interest areas of users on the social network.

In an exemplary embodiment of the present invention, as shown in FIG. 3B, the links may include user link. User link may be formed when there are common users between two communities. For example, a user can be a member of photography community as well as a member of golf community. In this case, user link may connect two nodes photography and golf respectively.

In another exemplary embodiment of the present invention, the links may include buddy link. Buddy link may be formed when members of one community are buddies with members of another community. In yet another exemplary embodiment of the present invention, an, interest link may be formed between two communities that are related. For example, a music community and a dance community may be linked by an interest link. In another exemplary embodiment of the present invention, an acquaintance link may be formed between two communities, if a member of one community has frequent conversations with a member of another community and have no other relationships between them. The acquaintance link may appear after the frequency of communication between the two communities exceeds a predetermined threshold. In an embodiment of the present invention, one or more communities may be linked through more than one link.

Each of the community links on the community network possesses different levels of strength which is determined based on one or more factors. Strength determines effectiveness of a link and allows comparison of two links. Factors that determine strength of each link are dependent on the type of the link. In an embodiment of the present invention, strength of a link may include a weak link or a strong link. Factors that establish a ‘user link’ as a weak link may include less number of common members between two communities, majority of common members being mainstream or laggers, inactive members or moderately active members and small community. Factors that establish a ‘user link’ as a strong link may include more number of common members, majority of common members being leaders, active members (communicating via e-mails and blog postings), highly active members and large community. Factors that establish a ‘buddy link’ as a weak link may include lesser number of buddy relationships and infrequent communication with buddy. Factors that establish a ‘buddy link’ as a strong link may include more number of buddy relationships and frequent communication between buddies.

Further, factors that establish a weak link between communities may include majority of members of two communities having dissimilar interests, members of two communities not engaging in similar activities, and less number of users browsing through subject matter related to both the communities. Furthermore, factors that establish a strong link between communities may include majority of members of two communities having similar interests, majority of members of two communities engaging in similar activities and more number of users browsing through subject matter related to both the communities. In an embodiment of the present invention, if a user connecting two nodes is a leader, then the link is a strong link as compared to a link where the user connecting two nodes is a mainstream.

In various embodiments of the present invention, for any two communities, the strongest link indicates strongest bond between the two communities. A community-community weight is assigned to community links based on strength of community links. In an embodiment of the present invention, each of the links is assigned a community-community weight on a scale of 1 to 10. The weights represent relationship between different communities. In an embodiment of the present invention, the user network 302 facilitates to determine suitable product that can be sold to the user. In another embodiment of the present invention, the user network 302 facilitates to determine other users who can influence the user to buy a product using information on the links. In yet another embodiment of the present invention, the user network 302 facilitates to determine other users whom the user can influence to buy a product. In various embodiments of the present invention, the interface modules 104, 106 sends data related to product network and user network to the influence commerce network management module 108.

The influence commerce network management module 108 is a software module configured to generate a product-community network using the product network and user network. The product-community network is referred as influence commerce network. In an embodiment of the present invention, the influence network management module 108 facilitates management of the influence commerce network. The influence commerce network management module 108 further comprises a data analyzer 116, an influence commerce network builder 118 and a network store 120:

The data analyzer 116 is a software module configured to facilitate analyzing data received from the activity tracker 102 and the interface module 104. In an embodiment of the present invention, the data analyzer 116 is configured to analyze the data related to product network and user network. In another embodiment of the present invention, the data analyzer 116 is configured to analyze data related to activities performed by users in e-commerce network 112 and social network 114.

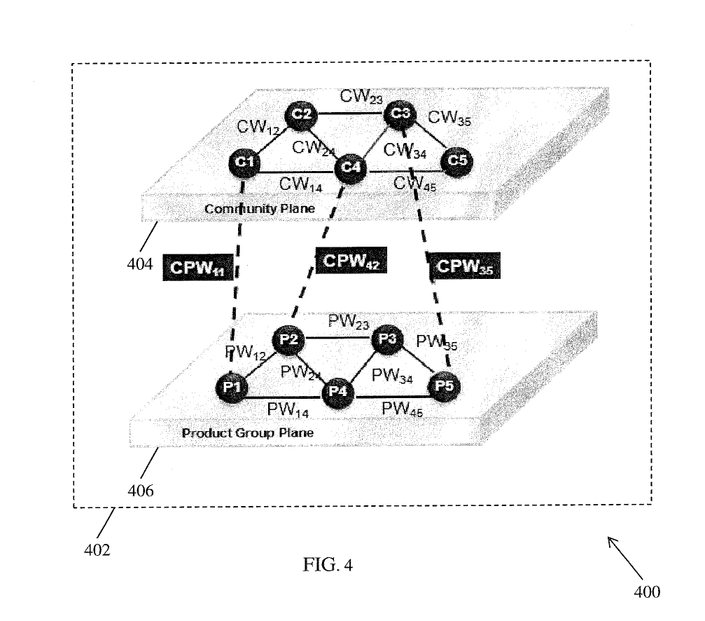

The influence commerce network builder 118 is a software module configured to process the analyzed data received from the data analyzer 108 and build the influence commerce network. In an embodiment of the present invention, the influence commerce network builder 118 is configured to derive relationships/links between users and products using the analyzed data. In another embodiment of the present invention, the influence commerce network builder 118 determines level of influence between users in the product network and user network. In yet another embodiment of the present invention, the influence commerce network builder 118 calculates strengths of the links based on the relationships derived. In another embodiment of the present invention, the influence commerce network builder 118 is configured to assign weights to the links based on the relationships. The influence commerce network is depicted in FIG. 4, in an exemplary embodiment of the present invention. FIG. 4 illustrates a graphical representation of an influence commerce network 402 which is a hybrid network which is formed by combining the user network and the product network. The community plane of the user network and product group plane of the influence commerce network 402 may be presented as parallel planes. The influence commerce network 402 reflects list of communities, list of product groups, users related to communities, and products related to one or more product groups.

The influence commerce network 402 facilitates retailers to determine relationships between users/communities and products. The influence commerce network 402 facilitates retailers to understand user behavior on the e-commerce network and social networking website and factors that can influence a user to buy a product. In an embodiment of the present invention, the links between users and products is the key to connect the two networks. The links facilitate to identify users and relevant products.

In an embodiment of the present invention, the influence commerce network 402 may be updated using data collected from users and products. The user network 402 and product network 404 may provide features that establish new relationships among users, products and between users and products. For example, users of social networking websites may communicate with the external users using call, Short Messaging Service (SMS) or e-mail and the contacts of users who are not part of the influence commerce network can be obtained and incorporated. Similarly, features may be incorporated in the product networks to invite other users or recommend a product. New links can be established based on linking of two networks. The links connecting the user network 402 and product network 404 may be referred as community-product links (CP link). The community-product links connect a product or product group to most relevant community and represent the relationships between communities and products. In an exemplary embodiment of the present invention, communities may be associated with products based on users' purchase history, browsing patterns and user profiles representing interest areas of the user.

The CP links possesses different levels of strength which is determined based on one or more factors. Community-product weight is assigned to each of the community-product links based on strength of each link, as shown in FIG. 4. For example, a community-product link is referred as a weak link when a user receives recommendation for a product in the community-product link or when a user browses a product in the same link. A community-product link is referred as a strong link when a user adds a product to favorites or shares with other users who desire to buy a product in the community-product link or buys a product in the community-product link.

In an embodiment of the present invention, based on data from the activity tracker 102, the community-community weights may be dynamically updated as relationship between users in two communities change. For example, relationship between two communities may change if more number of users in the communities becomes friends owing to their communication on the communities. This change may be reflected dynamically in the community plane of the influence commerce network 402. In another embodiment of the present invention, product-product weights may also be dynamically updated in the product plane of the influence commerce network 402. In yet another embodiment of the present invention, community-product weights may also be updated dynamically based on a change in relationship between a community and a product group owing to factors that include more buyers from a particular community.

In various embodiments of the present invention, community-community weights, product-product weights and community-product weights in the influence commerce network 402 is used by the retailers to identify targeted users for promotion of products. The weights are assigned by calculating strength of each of the links. A community link between two communities on a community plane of the influence commerce network 402 is an aggregation of one or more links that make up the relationship. For example, if twenty users are common between two communities then there would be twenty links with different weights and an aggregation of the twenty links form a link that represent relationship between two communities and strength of the community link.

In an exemplary embodiment of the present invention, the following equation may be used to calculate strength of a single link in a community link.

$${CS}_{i} = {\sum }_{K = 1}^{K = N} {S}_{k , l}$$

where, communities are represented as Ci (i.e. C1, C2, C3 etc., as shown in FIG. 4) and CSi represents community strengths. N represents number of points in the community. A point is represented by k which further represents a user who has registered for that community. Strength of each point k in community is represented as (sk, i). Strength of each point may depend on one or more factors as mentioned previously.

In another exemplary embodiment of the present invention, weight of a link CWij connecting communities Ci and Cj may be determined by number of common points N between two communities and strength of each common point k between Ci and Cj (sk, ij) as represented by the following equation.

$${CW}_{ij} = {\sum }_{K = 1}^{k = N} {S}_{k , ij} .$$

In an embodiment of the present invention, the strength of the community-community link may be calculated by aggregating the strengths of the one or more links and assigning a weight on a scale of 1 to 10 based on the calculated strength. In another embodiment of the present invention, the strength of the community link may be calculated by aggregating the weights of the one or more links. The weights CW12, CW23, etc. represent aggregation of relationships between one or more links in a community link.

In another exemplary embodiment of the present invention, the following equation may be used to calculate strength of a single link in a product-product link.

$$\cdot P : {S}_{i} = {\sum }_{K = 1}^{K = N} {S}_{k , l}$$

where, products are represented as Pi (i.e. P1, P2, P3 etc., as shown in FIG. 4) and PSi represents product group strengths. N represents number of points in the product group. A point is represented by k which further represents a user who has registered for that product group. Strength of each point k in community is represented as (Sk, i). Strength of each point may depend on one or more factors as mentioned previously.

In another exemplary embodiment of the present invention, weight of a link PWij connecting product groups Pi and Pj may be determined by number of common points N between two product groups and strength of each common point k between Pi and Pj (Sk, ij) as represented by the following equation.

$${PW}_{ij} = {\sum }_{K = 1}^{k = N} {S}_{k , ij}$$

In an embodiment of the present invention, the strength of the product-product link may be calculated by aggregating the strengths of the one or more links and assigning a weight on a scale of 1 to 10 based on the calculated strength. In another embodiment of the present invention, the strength of the product-product link may be calculated by aggregating the weights of the one or more links. The weights PW12, PW23 etc. represent aggregation of relationships between one or more links in a product-product link.

In yet another exemplary embodiment of the present invention, the following equation may be used to calculate weight of a community-product link.

$$C P {W}_{ij} = {\sum }_{k = 1}^{k = N} {\sum }_{l = 1}^{l = {n}_{k}} {S}_{l , ij}$$

weight of a link CPWij connecting community Ci and product group Pj is determined by number of users in Ci associated with a product from product group Pj. Number of products in Pj with which a single k in Ci is associated is (nk). Strength of each association of k (Sl,ij). As shown in FIG. 4, the links CPW11, CPW42, CPW36 represent relationships between product groups and communities.

Referring back to FIG. 1, the network store 120 is a software module configured to store data related to the influence commerce network. The influence commerce network engine 110 is a software module configured to generate an influence commerce network graph representing the influence commerce network. The influence commerce engine 110 is further configured to identify targeted users for promoting products using the influence commerce network. The influence commerce engine 110 is configured to strategize a marketing strategy for a product in the product network or a new product to be introduced in the market. In various embodiments of the present invention, the influence commerce engine 110 comprises an influence network analyzer 122, an influence graph builder 124, a strategy identifier 126, and a target mapping module 128.

The influence network analyzer 122 is a software module configured to obtain data related to the influence commerce network and analyze the data. The influence graph builder 124 is a software module configured to build an influence commerce graph using the analyzed data from the influence network analyzer 122. The strategy identifier 126 is a software module configured to facilitate generating marketing strategies for promotion of products using the influence commerce graph. The target mapping module 128 is a software module configured to map a product to a targeted user using the information from the strategy identifier 126. In an embodiment of the present invention, the output from the target mapping module 120 may be provided to modules such as recommendation module (not shown) and advertising module (not shown).

The reporting module 130 is a software module configured to generate reports required for marketing and promotion of products. In an embodiment of the present invention, the reporting module 130 is configured to analyze the influence commerce network and generate reports. In an exemplary embodiment of the present invention, the reports may include influence network reports representing behavior of a user in a community towards a product in product network and strategy report representing marketing strategies designed using the influence commerce network.

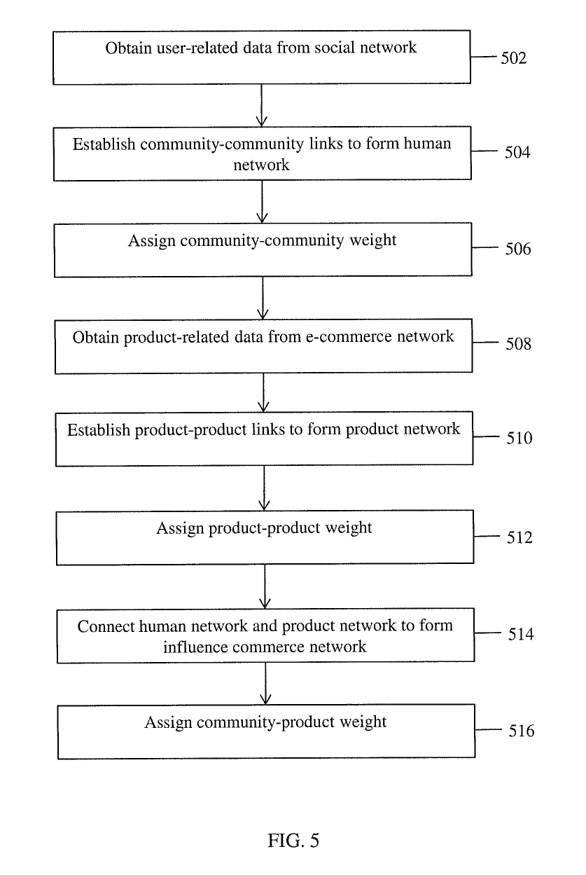

FIG. 5 is a flowchart illustrating a method for building an influence commerce network, in accordance with an embodiment of the present invention.

At step 502, user-related data is obtained from social networks. In an embodiment of the present invention, the user-related data includes user's browsing pattern and purchase history of products. In another embodiment of the present invention, the user-related data includes user interactions in the form of rating, recommendation or add to once favorites list. In yet another embodiment of the present invention, the user-related data includes user's points of interaction with the e-commerce network.

At step 504, community links are established between communities in a social network to form a user network. In an embodiment of the present invention, the communities represent interest areas of users on the social network. The links between the communities represent relationship therebetween which is established based on the user-related data.

At step 506, a community-community weight is assigned to each of the community links. In an embodiment of the present invention, the community-community weight is assigned based on strength derived for each of the links.

At step 508, product-related data is obtained from e-commerce networks. In an embodiment of the present invention, the product-related data comprises description, product specification, cost of products etc.

At step 510, product-product links are established between product groups in an e-commerce network to form a product network. In an embodiment of the present invention, the links represent relationship between products in product groups as well as between products with other products in product groups. The links are established using the product-related data.

At step 512, a product-product weight is assigned to each of the product-product links. In an embodiment of the present invention, the product-product weight is assigned based on strength derived on each of the product links.

At step 514, the product network and the user network is connected based on the user-related data and the product-related data to form a product-community network. The product-community network may be referred as influence commerce network. In another embodiment of the present invention, the influence commerce network may be updated based on new user-related data and/or product-related data.

At step 516, a community-product weight is assigned to each of the community-product link. In an embodiment of the present invention, the community-product weight is assigned based on strength derived on each of the community-product links.

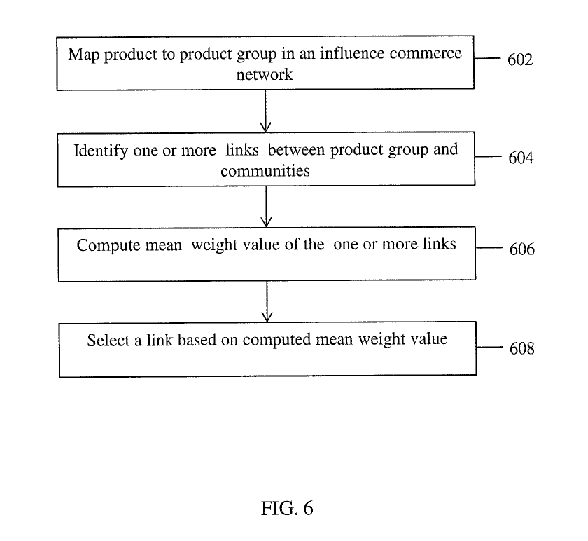

FIG. 6 is a flowchart illustrating a method for identifying a targeted user for promotion of products, in accordance with an embodiment of the present invention.

At step 602, a product is mapped to a product group in an influence commerce network based on characteristics of the product. In an exemplary embodiment of the present invention, a new product P is to be marketed. Using the influence commerce network, the product P is mapped to a relevant product group in the influence commerce network. Referring to FIG. 4, P is mapped to P1 in the influence commerce network based on characteristics of P.

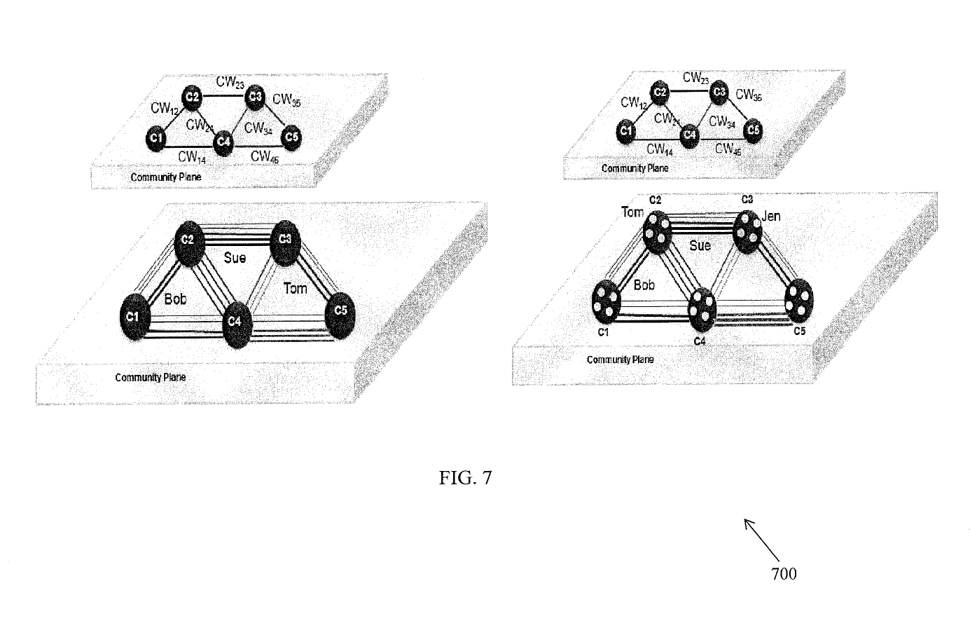

At step 604, one or more links connecting the product group to one or more communities in an influence commerce network is identified. In an embodiment of the present invention, one or more links between P and one or more communities in the influence commerce network are identified. For example, one or more links may include community-product link between P1 and C1, community-product link between P1 and C2, community-product link between P1 and C3 via C2, community-product link between P1 and C3 via C4 etc. In various embodiments of the present invention, each community link in the community plane of the influence commerce network comprises one or more ‘user’ links. Each community link can be decomposed to identify relevant information such as relationships between users existing in the network. The relevant information on the links may be used to identify the targeted user or market for promoting the product. In an embodiment of the present invention, the relationships indicate the extent to which users in the network can be influenced into buying a product or a user's ability to influence other users in the network to buy a product. Each user link may be labeled with a user name. Referring to FIG. 7, a user link labeled ‘Bob’ between communities C1 and C2 may be identified to be influencing a user link labeled ‘Sue’ between communities C2 and C3 based on the relationship between users Bob and Sue. Further, each community node in the community plane comprises one or more community nodes or members which may be labeled with a user name (e.g. Tom, Jen etc.). By decomposing the links, it can be inferred that Bob can influence Tom and Sue in C2, and Sue can influence Bill and Jen in C3 etc. Further, Bob's influence on Sue may be considered to be high if Bob buys a product and recommends Sue to buy the product.

At step 606, mean weight value of the one or more links is computed. In an embodiment of the present invention, each community link in the community plane comprises of one or more links with different weights. The weights are indicative of strengths of the links. Referring to FIG. 4, weight CPW11 is assigned between community-product link P1 and C1, weight CW12 is assigned between community link C1 and C2, weight CW23 is assigned between community link C2 and C3, weight CW14 is assigned between C1 and C4 and weight CW34 is assigned between C4 and C3. The weights are computed to obtain a mean weight value.

At step 608, a link is selected based on the computed mean weight value. In an embodiment of the present invention, a link with largest mean weight is identified and selected. In another embodiment of the present invention, multiple links are analyzed in descending order of mean weights (e.g. 2 to n (where, n>2)). A particular link may be selected from the multiple links based on predetermined condition. For example, a predetermined condition may include size of target market for promoting the product. In another embodiment of the present invention, if two links have the same mean weight value and is the largest value, the link with the shorter path is selected.

In various embodiments of the present invention, relevant information in the selected link is used for identifying targeted users for promoting the product. The relevant information includes names of users and relationship between the users with other users. This facilitates identifying users who can influence other users to view or buy the product.

In another embodiment of the present invention, for a particular user, suitable product may also be selected using the influence commerce network. The user may be mapped to a community (e.g. Cl) and links may be computed from the user to each of the product groups in the product network of the influence commerce network. Mean weight may be computed on the links to identify a product group with the largest mean weight. In case two links are identified having same computed mean weight value, the link with shorter path is selected. In yet another embodiment of the present invention, using relevant information in the product-product link, other products which may be promoted along with the selected product may also be detected.

The present invention may be implemented in numerous ways including as a apparatus, method, or a computer program product such as a computer readable storage medium or a computer network wherein programming instructions are communicated from a remote location.

Various embodiments of the present invention, may be implemented via one or more computer systems. The computer system includes at least one processing unit and memory. The processing unit executes program instructions and may be a real or a virtual processor. The computer system is not intended to suggest any limitation as to scope of use or functionality of described embodiments. Typical examples of a computer system include a general-purpose computer, a programmed microprocessor, a micro-controller, a peripheral integrated circuit element, and other devices or arrangements of devices that are capable of implementing the steps that constitute the method of the present invention. In an embodiment of the present invention, the memory may store software for implementing various embodiments of the present invention.

The present invention may suitably be embodied as a computer program product for use with a computer system. The method described herein is typically implemented as a computer program product, comprising a set of program instructions which is executed by a computer system or similar device. The set of program instructions may be a series of computer readable codes stored on a tangible medium, such as a computer readable storage medium, for example, diskette, CD-ROM, ROM, or hard disk, or transmittable to a computer system, via a modem or other interface device, over either a tangible medium, including but not limited to optical or analogue communications lines. The implementation of the invention as a computer program product may be in an intangible form using wireless techniques, including but not limited to microwave, infrared, bluetooth or other transmission techniques. These instructions can be preloaded into a system or recorded on a storage medium such as a CD-ROM, or made available for downloading over a network such as the Internet or a mobile telephone network. The series of computer readable instructions may embody all or part of the functionality previously described herein.

While example embodiments of the invention have been illustrated and described, it will be clear that the invention is not limited to these embodiments only. Numerous modifications, changes, variations, substitutions and equivalents will be apparent to those skilled in the art without departing from the spirit and scope of the invention.

1. A computer-implemented method for generating an influence commerce network that facilitates to identify one or more targeted users for promotion of products, the computer-implemented method comprising:
generating a product network, via program instructions executed by a computer system, using data related to a plurality of products in an ecommerce website, wherein the generated product network represents one or more product-product links which represent relationship between related products from amongst the plurality of products;
generating a user network, via program instructions executed by a computer system, using data related to users present in a social networking website, wherein the user network represents one or more community links which represent relationship between users;
analyzing data, via program instructions executed by a computer system, related to the user network and the product network; and
connecting, via program instructions executed by a computer system, the product network and the user network based on the analyzed data to generate an influence commerce network, wherein the influence commerce network represents one or more community-product links that represent relationship between users in the user network and products in the product network for identifying one or more targeted users.

2. The method of claim 1, wherein generating a product network using data related to products in an ecommerce website comprises:
identifying data related to the plurality of products, via program instructions executed by a computer system, from the ecommerce networking website, wherein the data related to the plurality of products comprises at least one of:
product description, product specification, and cost of products;
aggregating the plurality of products, via program instructions executed by a computer system, into a plurality of product groups based on the identified data;
establishing one or more product-product links between at least two of the plurality of product groups, via program instructions executed by a computer system, wherein the product-product links represent relationship between the product groups;
deriving strength of each of the product-product links, via program instructions executed by a computer system, based on one or more predetermined factors, wherein the strength represents effectiveness of each of the product-product links; and
assigning a product-product weight to each of the product-product links, via program instructions executed by a computer system, based on the derived strength of each of the product-product links.

3. The method of claim 2, wherein establishing one or more product-product links between at least two of the plurality of product groups comprises establishing a common product-product link between product groups which comprise common product and a similar product-product link between product groups which comprise similar products.

4. The method of claim 2, wherein deriving strength of each of the product-product links comprises determining if the product-product links are a strong link or a weak link based on one or more predetermined factors, the predetermined factors include at least one of: number of products in the product groups, number of common users viewing products in each product group, and products purchased by common users.

5. The method of claim 4, wherein strength of each of the product-product links may be derived using the following equation:
$$\cdot P : {S}_{i} = {\sum }_{K = 1}^{K = N} {S}_{k , l}$$
where, P Si represents product group strength, k represents a user of the product group, N represents number of users of the product group and Sk,i represents strength of each product in the product group, wherein Sk,i is determined based on the one or more predetermined factors.

6. The method of claim 2, wherein assigning a product-product weight to each of the product-product links comprises assigning a weight on a scale of 1 to 10 based on the derived strength.

7. The method of claim 6, the product-product weight corresponding to each product-product link is determined by the following equation:
$${PW}_{ij} = {\sum }_{K = 1}^{k = N} {S}_{k , ij}$$
where, PWij represents product-product weight of a product-product link connecting two product groups Pi and Pj, Sk,ij represents strength of product groups Pi and Pj and N represents number of common users between two product groups Pi and Pj.

8. The method of claim 1, wherein generating a user network using data related to users in a social networking website comprises:
obtaining data related to the plurality of users, via program instructions executed by a computer system, from the social networking website, wherein the data related to the plurality of users facilitate determining interactions of the plurality of users in the social networking website;
aggregating the plurality of users, via program instructions executed by a computer system, into a plurality of communities based on the obtained data, wherein the plurality of communities represent interest areas of the one or more users;
establishing one or more community links between at least two of the plurality of communities, via program instructions executed by a computer system, wherein the one or more community links represent relationship between the communities;
deriving strength of each of the community links, via program instructions executed by a computer system, using one or more predetermined factors, wherein the strength represents effectiveness of each of the community links; and
assigning a community-community weight to each of the links, via program instructions executed by a computer system, based on the derived strength of each of the community links.

9. The method of claim 8, wherein strength of each of the community links may be derived using the following equation:
$${CS}_{i} = {\sum }_{K = 1}^{K = N} {S}_{k , l}$$
where, CSi represents community strength, k represents a user of the product group, N represents number of users in the community and Sk,i represents strength of each community link, wherein Sk,i is determined based on the one or more predetermined factors.

10. The method of claim 8, wherein the community-community weight corresponding to each community link is determined by the following equation:
$${CW}_{ij} = {\sum }_{K = 1}^{k = N} {S}_{k , ij}$$
where CWij represents weight of a link connecting communities Ci and Cj, Skij represents strength of each link between Ci and Cj, k represents user and N represents number of common users between communities Ci and Cj.

11. The method of claim 1, wherein connecting the product network and the user network to build an influence commerce network comprises:
deriving strength of each of the community-product links, via program instructions executed by a computer system, based on one or more predetermined factors, wherein the strength represents effectiveness of each of the community-product links;
assigning a community-product weight to each of the links, via program instructions executed by a computer system, based on the derived strength of each of the community-product links.

12. The method of claim 11, wherein the community-product weight corresponding to each of the community-product link is determined by the following equation:
$$C P {W}_{ij} = {\sum }_{k = 1}^{k = N} {\sum }_{l = 1}^{l = {n}_{k}} {S}_{l , ij}$$
CPWij represents weight of community-product link connecting community Ci and product group Pj, N represents number of users in Ci associated with a product from product group Pj, nk represents number of products in Pj with which a user in Ci is associated and (Sl,ij) represents strength of each association of user with products

13. A method for identifying a targeted user for promotion of products using an influence commerce network, the method comprising:
mapping a product, via program instructions executed by a computer system, to a product group in an influence commerce network, wherein the product is mapped to the product group based on characteristics of the product;
identifying one or more community-product links, via program instructions executed by a computer system, wherein the community-product links connect the product group to one or more communities in the influence commerce network;
computing a mean weight value, via program instructions executed by a computer system, for each of the identified community-product links;
selecting a community-product link, via program instructions executed by a computer system, based on the computed mean weight value, wherein the selected community-product link connects the product group to one or more communities; and
identifying one or more users, via program instructions executed by a computer system, from the one or more communities connected to the product group by the selected community-product link.

14. The method of claim 13, wherein mapping a product to a product group in an influence commerce network comprises:
identifying a product group in an influence commerce graph representative of the influence commerce network based on characteristics of the product, wherein the product group is represented as a node in the influence commerce graph; and
mapping the product to the identified product group.

15. The method of claim 14, wherein identifying one or more community-product links that connect the product group to one or more communities in the influence commerce network comprises:
determining the community-product links which connect the identified product group node to one or more community nodes in the influence commerce graph; and
identifying the community links in a community plane of the influence commerce graph that correspond to the community-product links;
determining relationship between users associated with the communities which are connected by the identified community links, wherein the relationship is determined using information from the community links; and
identifying one or more community-product links based on the determined relationships, wherein the relationship between users signifies the extent of influence one user in a community has on another user of one or more communities, the communities being connected by the community links that correspond to the community-product links.

16. The method of claim 15, wherein computing a mean weight value for each of the identified community-product links comprises computing a mean weight value of the weights assigned to the identified community-product links.

17. The method of claim 16, wherein selecting a community-product link based on the computed mean weight value comprises at least one of: selecting a community-product link with largest mean weight value, selecting a community-product link with shortest path in the influence commerce graph if at least two community-product links have same computed mean value and selecting a community-product link based on market conditions.

18. A system for building an influence commerce network that facilitates to identify a targeted user for promotion of products, the system comprising:
a first interface module in communication with a processing unit and configured to generate a product network using data related to a plurality of products in an ecommerce website, wherein the product related data is stored in a memory and further wherein the product network includes one or more product-product links which represent relationship between related products from amongst the plurality of products;
a second interface module in communication with the processing unit and configured to generate a user network using data related to users present in a social networking website, wherein the user related data is stored in the memory and further wherein the user network includes one or more community links which represent relationship between users;
an influence commerce network management module in communication with the processing unit and configured to:
receive data related to the user network and the product network from the first and second interface modules respectively and storing the received data in the memory; and
analyze the received data and connect the product network and the user network based on the analyzed data to generate an influence commerce network, wherein the influence commerce network includes one or more community-product links that represent relationship between users in the user network and products in the product network.

19. The system of claim 18, wherein the system further comprises:
an activity tracker in communication with the processing unit and configured to:
monitor activities of the users in the social networking website and users in the ecommerce website;
identify data related to activities which are relevant for generating an influence commerce network; and
send the identified data to the influence commerce network management module.

20. The system of claim 18, wherein the influence commerce network management module comprises a data analyzer, the data analyzer in communication with the processing unit and configured to receive and analyze data received from the first and second interface modules respectively.

21. The system of claim 19, wherein the influence commerce network management module comprises a data analyzer, the data analyzer is in communication with the processing unit and configured to receive and analyze the data received from the activity tracker.

22. The system of claim 18, wherein the influence commerce network management module comprises an influence commerce network builder, the influence commerce network builder in communication with the processing unit and configured to process the analyzed data and generate the influence commerce network.

23. The system of claim 18, wherein the influence commerce network management module comprises a network store, the network store being configured to store data related to the influence commerce network.

24. The system of claim 23 further comprising an influence commerce network engine in communication with the processing unit and configured to generate an influence commerce graph representing the influence commerce network using the data stored in the network store.

25. The system of claim 23, wherein the influence commerce network engine comprises:
an influence network analyzer, the influence network analyzer in communication with the processing unit and configured to receive and analyze the data stored in the network store; and
an influence graph builder, the influence graph builder in communication with the processing unit and configured to receive the analyzed data from the influence network analyzer and generate a graph using the analyzed data.

26. The system of claim 24, wherein the influence commerce network engine comprises:
a strategy identifier in communication with the processing unit and configured to facilitate determining one or more strategies for promotion of products using the generated influence commerce graph; and
a target mapping module in communication with the processing unit and configured to
map a product in the product network using the generated influence commerce graph based on the determined one or more strategies, wherein the mapping is performed based on one or more characteristics of the product; and
identify a targeted user in the user network for promotion of a product in the product network using the generated influence commerce graph based on the mapping.

27. A computer-implemented method for generating an influence commerce network that facilitates to identify one or more targeted users for promotion of products, the computer-implemented method comprising:
generating a product network, via program instructions executed by a computer system, using data related to a plurality of products in an ecommerce website, wherein the generated product network represents one or more product-product links which represent relationship between related products from amongst the plurality of products;
generating a user network, via program instructions executed by a computer system, using data related to users present in a social networking website, wherein the user network represents one or more community links which represent relationship between users;
analyzing data, via program instructions executed by a computer system, related to the user network and the product network; and
connecting, via program instructions executed by a computer system, the product network and the user network based on the analyzed data to generate an influence commerce network, wherein the influence commerce network represents one or more community-product links that represent relationship between users in the user network and products in the product network for identifying one or more targeted users of products.
